(19) United States
(12) Patent Application Publication
(10) Pub. No.: US 2003/0214757 A1
(43) Pub. Date: Nov. 20, 2003

(54) Ramp for magnetic read/write apparatus and magnetic read/write apparatus using the same

(76) Inventors: Kimihide Tokura, Ome-shi (JP); Hiromichi Takami, Ome-shi (JP)

Correspondence Address: PILLSBURY WINTHROP, LLP, P.O. BOX 10500, MCLEAN, VA, 22102, US

(21) Appl. No.: 10/026,947

(22) Filed: Dec. 27, 2001

(30) Foreign Application Priority Data
Dec. 27, 2000 (JP) 2000-397292

(51) Int. Cl. G11B 5/54

(52) U.S. Cl. 360/254.7

(57) ABSTRACT

A ramp formed of a material made by adding an inorganic filler to a thermoplastic resin or a thermosetting resin.

### CROSS-REFERENCE TO RELATED APPLICATIONS

This application is based upon and claims the benefit of priority from the prior Japanese Patent Application No. 2000-397292, filed Dec. 27, 2000, the entire contents of which are incorporated herein by reference.

### BACKGROUND OF THE INVENTION

1. Field of the Invention

The present invention relates to a load-unload type magnetic read/write apparatus and to a ramp used in the magnetic read/write apparatus.

2. Description of the Related Art

The load-unload type magnetic read/write apparatus is provided with a member called a ramp that acts as a head shunting mechanism during the non-read/write period of the magnetic read/write apparatus. The ramp is located outside the portion in which the magnetic recording medium is located in order to permit the head to be shunted outside the magnetic recording medium during the non-read/write period. During the read/write period, the head can be moved from the ramp onto the magnetic recording medium.

The head is mounted on a suspension assembly using a head supporting member, for example, a leaf spring. A projection called a tab is mounted on thee tip of the suspension assembly. The tab is mounted on and can be slid along with the ramp.

The ramp is designed to be capable of stably supporting the tab during the non-read/write period and is also designed to permit the tab to be slid easily onto the magnetic recording medium during the read/write period, i.e., is designed to be capable of loading/unloading. Mainly, the ramp is formed of a resin.

It should be noted that, if the sliding resistance between the tab and the ramp is large, the load-unload operation is hindered. To overcome this difficulty, it was customary to add an organic lubricant, particularly, a fluorine-based lubricant, to the resin from which the ramp was formed in order to improve the sliding characteristics.

For example, Jpn. Pat. Appln. KOKAI Publication No. 10-312657 discloses a ramp comprising a ramp supporting member formed of a thermoplastic polyimide (aurum) and a sliding member formed of a polytetrafluoroethylene (PTFE)-containing liquid crystal polymer (vectra). Also, Jpn. Pat. Appln. KOKAI Publication No. 10-302421 teaches the idea of forming a dry lubricating film (tetrafluoro ethylene resin, imide-based resin, etc.) on the sliding surface between the tab and the ramp.

However, the fluorine-based lubricant has poor compatibility with the resin. Therefore, the sliding portion of the resulting ramp exhibits noticeably nonuniform sliding resistance and is unstable, resulting in failure to perform a satisfactory load/unload operation.

### BRIEF SUMMARY OF THE INVENTION

An object of the present invention, which has been achieved in view of the situation described above, is to provide a magnetic read/write apparatus that permits the sliding resistance and the nonuniformity of the sliding resistance in the sliding portion between the ramp and the head to be suppressed in order to achieve satisfactory sliding.

Another object of the present invention is to provide a ramp that permits the sliding resistance and the nonuniformity of the sliding resistance between the head and the sliding portion to be suppressed in order to achieve satisfactory sliding.

According to a first aspect of the present invention, a ramp is provided for a magnetic read/write apparatus for shunting a magnetic read/write head to the outside of a magnetic recording medium during the non-read/write period, the ramp containing mainly at least one molding resin selected from a thermoplastic resin and a thermosetting resin, and an inorganic filler used as an additive.

According to a second aspect of the present invention, a magnetic read/write apparatus is provided, comprising a magnetic recording medium, a head supporting a read/write element for reading data from and writing it to the magnetic recording medium, a suspension assembly for supporting the head, and a ramp mounted on the outside of the magnetic recording medium and brought into contact with a part of the suspension assembly in order to hold the suspension assembly while permitting it to slide, wherein the ramp contains mainly at least one molding resin selected from a thermoplastic resin and a thermosetting resin, and an inorganic filler used as an additive.

Additional objects and advantages of the present invention will be set forth in the description that follows, and in part will be obvious from the description, or may be learned by practice of the present invention. The objects and advantages of the present invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the present invention, and together with the general description given above and the detailed description of the embodiments given below, serve to explain the principles of the present invention.

FIG. 1 is a front view exemplifying a magnetic read/write apparatus of the present invention;

FIG. 2 is a front view exemplifying a magnetic read/write apparatus of the present invention;

FIG. 3 shows how the sliding resistance occurring in the present invention is measured; and

FIG. 4 shows how the sliding resistance occurring in the present invention is measured.

### DETAILED DESCRIPTION OF THE INVENTION

The present invention provides a ramp for the magnetic read/write apparatus. The ramp of the present invention is used for shunting the magnetic read/write head to the outside of the magnetic recording medium during the non-read/write period. A thermoplastic resin or a thermosetting resin is used as the main component of the material constituting the ramp. Also, an inorganic filler is added to the thermoplastic resin or the thermosetting resin.

The present invention also provides a magnetic read/write apparatus using the ramp referred to above. The magnetic read/write apparatus of the present invention comprises a magnetic recording medium, a head supporting a read/write element for reading data from and writing it to said magnetic recording medium, a suspension assembly for supporting said head, and the ramp referred to above, which is mounted on the outside of said magnetic recording medium and brought into contact with a part of said suspension assembly so as to hold said suspension assembly while permitting it to slide.

According to the present invention, it is possible to lower the sliding resistance and the nonuniformity of the sliding resistance between the ramp and the head of the magnetic read/write apparatus so as to permit excellent sliding.

An inorganic filler is added to the ramp of the present invention in an amount of preferably 4% by weight or less. The inorganic filler provides a contact point in the contact surface with the tab because the inorganic filler is harder than the resin. Since the tab is supported at a hard point, the sliding resistance is lowered. The nonuniformity of the sliding resistance is also lowered.

Also, since the inorganic filler used in the present invention can be dispersed uniformly in a plastic material, it is possible to reduce the sliding resistance of the ramp in the sliding portion, compared with the use of a fluorine-based resin, which has poor compatibility with the resin.

As described above, according to the present invention, 4% by weight or less of an inorganic filler is added to the material constituting the ramp in order to achieve smoother sliding. Also, since the desired effect can be obtained with the addition of a small amount of inorganic filler, the ramp can be manufactured at a low cost.

The following experiment was conducted to look into a suitable addition amount of the inorganic filler. Specifically, the load/unload test was repeated 500,000 times under a suspension load of 2.0 gf. The test results were evaluated by measuring the shape of the tab before and after the test. A liquid crystal polymer containing p-hydroxy benzoate and terephthalic acid as the main raw materials was used as the ramp material. The ramp material further contained TiO₂ as a filler. Various ramp materials were prepared by changing the proportion of filler. The test results are given below:

| Addition Amount (wt %) | Tab Abrasion |
|---|---|
| of Inorganic Filler | Amount (μm) |
| 4 | 0.00 |
| 5 | 0.02 |
| 8 | 0.03 |
| 10 | 0.05 |

As apparent from the test results given above, the tab is abraded if the proportion of inorganic filler exceeds 4% by weight. In other words, it is desirable to set the proportion of filler at 4% or less by weight.

Incidentally, it is desirable for the proportion of filler to fall within the range of between 0.05 and 4% by weight. If the proportion of inorganic filler is smaller than 0.05% by weight, the sliding resistance tends not to be lowered. On the other hand, if the proportion of inorganic filler exceeds 4% by weight, the tab is abraded, and the resulting powder tends, in turn, to abrade the ramp. It is furthermore desirable for the proportion of inorganic filler to fall within the range of between 0.5 and 2% by weight.

The inorganic filler used in the present invention includes, for example, a fused silica, a crystallized silica, a glass fiber, SiN, SiC, Al₂O₃, TiO₂, potassium titanate, CeO₂, Y₂O₃, ZnO, ZrO₂, SnO₂, Ho₂O₃, CuO and Mn₃O₄.

It is desirable for the inorganic filler to have an average diameter falling within a range of between 0.01 μm and 100 μm.

In order to improve the dispersion capability of the inorganic filler within the resin, it is possible to add an antistatic agent to the inorganic filler in advance. The antistatic agent used in the present invention includes, for example, distearyl glyceride, amino polymer, alkyltrimethylammonium cloride, alkyldimethylammonium sulfate, polyoxiethylenepropylene alkylether.

The inorganic filler is subjected to melt mixing with a thermoplastic resin or a thermosetting resin by using, for example, an extruder or a roll.

The thermoplastic resin or the thermosetting resin used in the present invention as the molding resin includes, for example, a liquid crystal polymer, polyamide, polycarbonate, polyethylene terephthalate, polybutylene terephthalate, polyphenylene ether, polyacetal, epoxy resin, phenol resin, polyethylene, polystyrene, and polypropylene. It is desirable to use a liquid crystal polymer containing p-hydroxy benzoate and terephthalic acid as main components and polyacetal. These resins permit further improvement of the sliding characteristics, the moldability, and the dimensional stability of the resin itself.

Also flexural modulus of elasticity and flexural strength of the molding resin can be determined by a method as defined by ASTM D290.

Examples of preferable flexural modulus of elasticity of the molding resin are 8.5 to 9.2 GPa relating to liquid crystal polymer, and 2.5 to 3.2 GPa relating to polyacetal. Examples of preferable flexural strength are 120 to 130 MPa relating to crystal polymer, 85 to 110 MPa relating to polyacetal.

The surface treatment method includes, for example, a method of coating the surface of the inorganic filler with a titanium-based coupling agent or a silane-based coupling agent. The coating method includes, for example, a method of dripping the coupling agent mentioned above while stirring the filler, a method of putting the coupling agent dissolved in a solvent onto the filler, a method of filtering the filler, followed by drying the filtered filler, and a method of spraying a solution of the coupling agent onto the filler.

The titanium-based coupling agent used in the present invention includes, for example, isopropyl triisostearoyl titanate, isopropyl tri(lauryl mistyl titanate), isopropyl isostearoyl dimethacryl titanate, isopropyl tri(dodecylbenzene sulfonate) titanate, isopropyl isostearoyl diacryl titanate, isopropyl tri(diisooctyl phosphate), and isopropyl trimethacryl titanate. On the other hand, the silane coupling agent used in the present invention includes, for example, vinyl triethoxy silane, vinyl tris(2-methoxyethoxy) silane, γ-glycidoxy propyl trimethoxy silane, γ-mercaptopropyl trimethoxy silane, and γ-aminopropyl triethoxy silane. The bonding between the resin and the inorganic filler can be strengthened by using these coupling agents.

The ramp of the present invention can be manufactured by, for example, injection molding, transfer molding or compression molding.

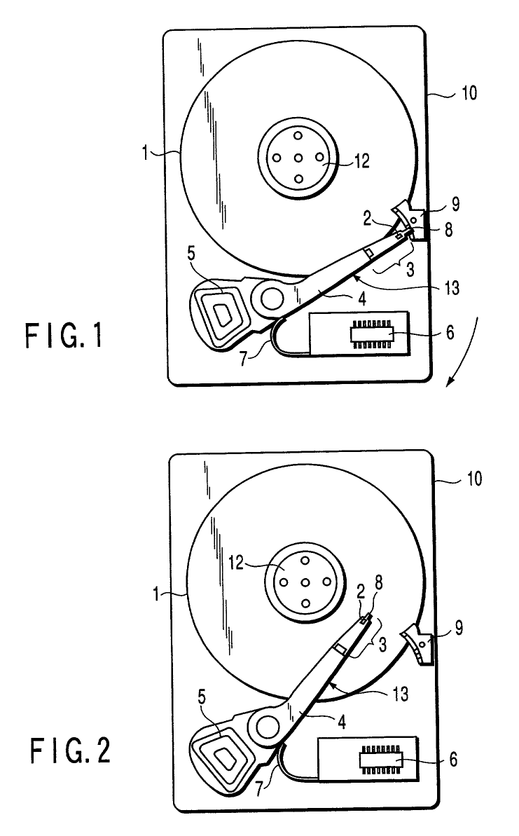

FIGS. 1 and 2 are front views each showing schematically an example the construction of the magnetic read/write apparatus of the present invention. Specifically, FIG. 1 shows the state in which the head is shunted (unloaded) onto the ramp arranged outside the magnetic recording medium during the non-read/write period, and FIG. 2 shows the state in which the head is loaded from the ramp onto the magnetic recording medium during the read/write period.

As shown in the drawings, the magnetic read/write apparatus of the present invention comprises an apparatus body 10. A magnetic disk 1 having a rigid structure (disk thickness/disk outer diameter >1/500) on which data can be recorded is mounted on a spindle 12 on the apparatus body 10. The magnetic disk 1 is rotated at a predetermined angular velocity by a spindle motor (not shown). Also, an actuator 13 having a magnetic head mounted thereon includes a suspension assembly 3 having the magnetic head 2 mounted thereon, an arm 4 supporting the suspension assembly 3, and a voice coil motor 5 for moving the arm 4.

The suspension assembly 3 gaining access to the magnetic disk 1 for reading/writing data is mounted on the tip region of the suspension made of a thin plate-like leaf spring, and a projection-like tab 8 is mounted on the tip edge of the suspension. A load of, for example, about 1.5 gf to about 3.5 gf is applied to the suspension. Further, a ramp 9, which is brought into contact with the tab 8 so as to support the tab 8 during the non-read/write period and the tab 8 is slid along so as to be moved onto the magnetic disk 1 during the read/write period, is arranged below the tab 8. The ramp 9 is made of a material containing a thermoplastic resin or a thermosetting resin as the main component and 0.05 to 4% by weight of an inorganic filler having a hardness higher than that of the main component resin. Also, the other end of the suspension assembly is connected to one edge of the arm 4 having, for example, a bobbin for holding a driving coil (not shown).

The voice coil motor 5, which is a kind of linear motor, is mounted on the other end of the arm 4. The voice coil motor 5 comprises a driving coil (not shown) wound around the bobbin portion and a magnetic circuit including a permanent magnet and a counter yoke. The permanent magnet and the counter yoke are arranged so that the driving coil is interposed therebetween.

The arm 4 is held by ball bearings (not shown) arranged in the upper portion and lower portion of a stationary shaft so as to be swung by the voice coil motor 5. In other words, the position of the suspension assembly on the magnetic disk 1 is controlled by the voice coil motor 5.

The voice coil motor 5 is controlled by a driving circuit 6 connected to a flexible cable 7 so as to effect loading onto the magnetic disk 1 as shown in FIG. 2 and to effect unloading from the magnetic disk 1 as shown in FIG. 1.

In the example shown in the drawings, the magnetic read/write apparatus comprises two disks and four heads.

It is desirable for the ramp of the present invention to exhibit a change in the sliding resistance with the contact portion of the head falling within a predetermined range, for example, falling within a range of between 1.8 gfcm and 2.6 gfcm, preferably between 2.0 gfcm and 2.5 gfcm. Also, it is desirable for the width of the change to be greater than 0.4.

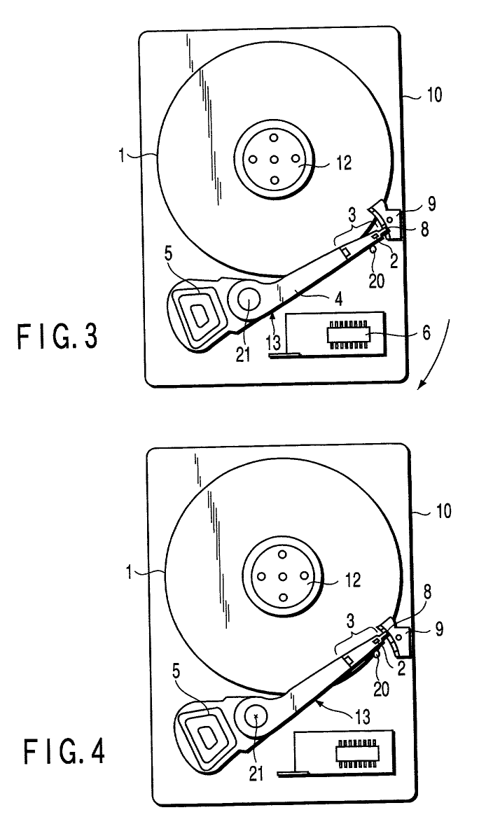

How to measure the sliding resistance value used in the present invention will now be described. The sliding resistance value was measured by using the magnetic read/write apparatus shown in FIGS. 3 and 4.

As apparent from FIG. 3, the magnetic read/write apparatus used for measuring the sliding resistance value is substantially equal in construction to the apparatus shown in FIG. 1, except that a load cell 20 is arranged on the side edge of the suspension assembly 3 and that the flexible cable 7 is cut away. Because of the particular construction, the suspension assembly does not receive the force produced by the voice coil motor 5 when the tab slides along the ramp.

In the apparatus shown in FIG. 3, the load cell 20 is fixed independent of the apparatus body 10. Further, the center 21 of rotation of the actuator 13 is fixed such that the apparatus body 10 is swingable about the center 21 of rotation.

The apparatus body 10 was swung about the center 21 of rotation in the direction denoted by an arrow by using the apparatus shown in FIG. 3, with the load cell 20 allowed to abut the side edge of the suspension assembly 3, so as to measure the force applied to the load cell 20, thereby obtaining the sliding resistance. FIG. 4 shows the state after swinging. The swing speed was set at 5°/sec. Even if the apparatus body 10 is swung, the actuator 13 is not moved because the suspension assembly 3 abuts the load cell 20. Since the ramp 9 is fixed to the apparatus body 10, the ramp 9 is moved together with the apparatus body 10. Since the ramp 9 is moved, while the actuator 13 remains stationary, the tab 8 slides along the ramp 9. The force received by the suspension assembly 3 from the ramp 9 is transmitted as a pressure to the load cell and, thus, the sliding resistance is measured.

The flat surface of the ramp 9 was used for measuring the sliding resistance. Five ramps were used for measuring the sliding resistance, and the minimum and maximum values of the sliding resistance were measured including the nonuniformity caused by the ramps and the nonuniformity caused by the locations.

The present invention will now be described in more detail.

### EXAMPLE 1

A ramp was made by injection molding of a material having a modulus of flexural elasticity of 8.8 GPa as defined by ASTM D790, said material comprising a liquid crystal polymer containing as main components p-hydroxy benzoate and terephthalic acid, and including 0.7% by weight of TiO₂ particles having an average particle diameter of 0.5 μm, which constituted an inorganic filler. The sliding resistance, which was measured by applying the ramp thus made to the apparatus shown in FIG. 3, was found to be 2.2 to 2.4 gfcm.

### EXAMPLE 2

A ramp was made by injection molding of a material having a flexural modulus of elasticity of 9.8 GPa as defined by ASTM D790, said material comprising a liquid crystal polymer containing as main components p-hydroxy benzoate and terephthalic acid, and including 1.0% by weight of fused silica particles having an average particle diameter of 3 μm, which constituted an inorganic filler. The sliding resistance, which was measured by applying the ramp thus made to the apparatus shown in FIG. 3, was found to be 2.3 to 2.5 gfcm.

### EXAMPLE 3

A ramp was made by injection molding of a material having a flexural modulus of elasticity of 13.2 GPa as defined by ASTM D790, said material comprising a liquid crystal polymer containing as main components p-hydroxy benzoate and terephthalic acid, and including 1.2% by weight of fused silica particles having an average particle diameter of 3 μm, which constituted an inorganic filler. The sliding resistance, which was measured by applying the ramp thus made to the apparatus shown in FIG. 3, was found to be 2.2 to 2.5 gfcm.

### EXAMPLE 4

A ramp was made by injection molding of a material having a flexural modulus of elasticity of 2.4 GPa as defined by ASTM D790, said material comprising polyacetal and including 1.0% by weight of TiO₂ particles having an average particle diameter of 0.5 μm, which constituted an inorganic filler. The sliding resistance, which was measured by applying the ramp thus made to the apparatus shown in FIG. 3, was found to be 2.3 to 2.4 gfcm.

### EXAMPLE 5

A ramp was prepared by injection molding of a material having a flexural modulus of elasticity of 2.7 GPa as defined by ASTM D790, said material comprising polyacetal and including 1.2% by weight of TiO₂ particles having an average particle diameter of 0.5 μm, which constituted an inorganic filler. The sliding resistance, which was measured by applying the ramp thus made to the apparatus shown in FIG. 3, was found to be 2.2 to 2.4 gfcm.

### EXAMPLE 6

A ramp was made by injection molding of a material having a flexural modulus of elasticity of 3.0 GPa as defined by ASTM D790, said material comprising polyacetal and including 1.7% by weight of SiC particles having an average particle diameter of 10 μm, which constituted an inorganic filler. The sliding resistance, which was measured by applying the ramp thus made to the apparatus shown in FIG. 3, was found to be 2.3 to 2.5 gfcm.

### COMPARATIVE EXAMPLE 1

Ramp material having a modulus of elasticity of 8.8 GPa of flexural elasticity modulus was prepared by adding 25% by weight of tetrafluoroethylene to a liquid crystal polymer similar to that used in Example 1. A ramp was then made by using the material thus prepared. The sliding resistance, which was measured as in Example 1, was found to be 2.0 to 3.0 gfcm.

### COMPARATIVE EXAMPLE 2

A ramp was made as in Example 1 by using polyacetal resin to which no inorganic filler or similar was added. The sliding resistance, which was measured as in Example 1, was found to be 2.8 to 3.5 gfcm.

The experimental data clearly support that the ramp according to the present invention permits reduction of the sliding resistance and the nonuniformity of the sliding resistance, as apparent from Examples 1 to 6. On the other hand, in Comparative Example 1 using a polymer having a fluorine-containing polymer mixed therein, it is certainly possible to reduce the minimum value of the sliding resistance. However, the nonuniformity of the sliding resistance was found to be large in Comparative Example 1. Also, in Comparative Example 2 using a resin to which no inorganic filler was added, the sliding resistance was found to be large. The nonuniformity of the sliding resistance was also found to be large.

Additional advantages and modifications will readily occur to those skilled in the art. Therefore, the present invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A ramp for a magnetic read/write apparatus to shunt a magnetic read/write head to the outside of a magnetic recording medium in the non-read/write period, said ramp containing mainly at least one molding resin selected from a thermoplastic resin and a thermosetting resin and an inorganic filler used as an additive.

2. A ramp for a magnetic read/write apparatus according to claim 1, wherein the content of said inorganic filler is not higher than 4% by weight.

3. A ramp for a magnetic read/write apparatus according to claim 2, wherein the content of said inorganic filler falls within a range of between 0.05 and 4% by weight based on said molding resin.

4. A ramp for a magnetic read/write apparatus according to claim 1, wherein said inorganic filler is subjected to a surface treatment with a titanium-based coupling agent.

5. A ramp for a magnetic read/write apparatus according to claim 1, wherein said inorganic filler is subjected to a surface treatment with an antistatic agent.

6. A ramp for a magnetic read/write apparatus according to claim 1, wherein said inorganic filler has an average particle diameter falling within the range of 0.1 μm to 100 μm.

7. A ramp for a magnetic read/write apparatus according to claim 1, wherein said inorganic filler is formed of at least one material selected from the group consisting of a fused silica, a crystallized silica, a glass fiber, SiN, SiC, Al₂O₃, TiO₂, potassium titanate, CeO₂, Y₂O₃, ZnO, ZrO₂, SnO₂, Ho₂O₃, CuO and Mn₃O₄.

8. A ramp for a magnetic read/write apparatus according to claim 1, wherein said molding resin consists essentially of polyacetal and said filler consists essentially of titanium dioxide.

9. A magnetic read/write apparatus, comprising a magnetic recording medium, a head supporting a read/write element for reading data from and writing it to said magnetic recording medium, a suspension assembly for supporting said head, and a ramp mounted on the outside of said magnetic recording medium and brought into contact with a part of said suspension assembly so as to hold said suspension assembly while permitting it to slide, wherein said ramp contains mainly at least one molding resin selected from a thermoplastic resin and a thermosetting resin and an inorganic filler used as an additive.

10. A magnetic read/write apparatus according to claim 9, wherein the content of said inorganic filler is not higher than 4% by weight.

11. A magnetic read/write apparatus according to claim 10, wherein the content of said inorganic filler falls within the range of 0.05 to 4% by weight based on said molding resin.

12. A magnetic read/write apparatus according to claim 9, wherein said inorganic filler is subjected to a surface treatment with a titanium-based coupling agent.

13. A magnetic read/write apparatus according to claim 9, wherein said inorganic filler is subjected to a surface treatment with an antistatic agent.

14. A magnetic read/write apparatus according to claim 9, wherein said inorganic filler has an average particle diameter falling within the range of 0.1 μm to 100 μm.

15. A magnetic read/write apparatus according to claim 9, wherein said inorganic filler is formed of at least one material selected from the group consisting of a fused silica, a crystallized silica, a glass fiber, SiN, SiC, Al₂O₃, TiO₂, potassium titanate, CeO₂, Y₂O₃, ZnO, ZrO₂, SnO₂, Ho₂O₃, CuO and Mn₃O₄.

16. A magnetic read/write apparatus according to claim 9, wherein said molding resin consists essentially of polyacetal and said filler consists essentially of titanium dioxide.

17. A magnetic read/write apparatus according to claim 9, wherein the width of change in the sliding resistance value between said head and said ramp falls within the range of 1.8 gfcm to 2.6 gfcm.

18. A magnetic read/write apparatus according to claim 9, wherein the load applied to said suspension assembly falls within the range of 1.5 gf to 3.5 gf.
